(19) United States
(12) Patent Application Publication
(10) Pub. No.: US 2008/0257012 A1
(43) Pub. Date: Oct. 23, 2008

(54) Co2 Tracing Method for Measuring Raw Exhaust Gas Flow Rate at Exit From an Internal Combusting Engine for a Motor Vehicle and Measuring Equipment for Carrying Out Said Method

(75) Inventors: Vincent Foulart, Rueil Malmaison (FR); Bertrand Petit, Vert Saint Denis (FR); Jean-Pierre Schiltz, Arpajon (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., BOULOGNE BILLANCOURT (FR)

(21) Appl. No.: 11/910,312

(22) PCT Filed: Mar. 28, 2006
(86) PCT No.: PCT/FR2006/050268

§ 371 Date: Jul. 1, 2008

(30) Foreign Application Priority Data
Mar. 30, 2005 (FR) 0503073

(51) Int. Cl. G01M 15/10; F01N 11/00

(52) U.S. Cl. 73/23.31; 73/114.71

(57) ABSTRACT

The invention relates to an CO₂ tracing method for measuring a raw exhaust gas (3) flow rate at exit from an internal combustion engine (1A) for a motor vehicle (1). The inventive CO₂ tracing method for measuring raw exhaust gas flow rate at exit from an internal combustion engine for a motor vehicle consists, prior to starting the motor vehicle internal combustion engine, in injecting a known flow rate of a gas CO₂ and N₂ mixture into a metering line (20) in such a way that a raw CO₂ analyser (22) and a diluted CO₂ analyser (24) are triggered.

The present invention relates in general to the measurement of the flow rate of exhaust gas output by an internal combustion engine of a motor vehicle.

It relates more particularly to a CO₂ tracing method for measuring the flow rate of the raw exhaust gas output by an internal combustion engine of a motor vehicle and a measurement installation for implementing the CO₂ tracing method of measurement.

The invention is particularly advantageously applicable for determining, second by second, the masses of the polluting constituents in the exhaust gas, the measurement of the exhaust gas flow rate being an intermediate step.

### TECHNOLOGICAL BACKGROUND

To measure by CO₂ tracing the masses of the polluting constituents of the raw exhaust gas output by an internal combustion engine of a motor vehicle, two types of analysis may be carried out.

It is possible to carry out an overall analysis of the concentrations of the polluting constituents of the raw exhaust gas output by an engine. In this case, the analysis carried out is an analysis using a sampling bag, carried out over the entire duration of the measurement cycle. The mass of each of the polluting constituents emitted over the entire measurement cycle is thus obtained.

When it is desired to analyze the masses of the polluting constituents of the exhaust gas second by second, in order to make adjustments to the engine, an analysis referred to as “modal” analysis is carried out.

By determining the flow rate of the raw exhaust gas second by second output by the engine second by second, it is possible to determine the masses of the polluting constituents of the exhaust gas second by second.

The two types of measurement—measurement by overall analysis and measurement by modal analysis—are usually combined and the results obtained are correlated.

Currently, one such CO₂ tracing method for measuring the flow rate of the raw exhaust gas output by an internal combustion engine of a motor vehicle comprises the following steps:
a flow of raw exhaust gas output by an exhaust line of an internal combustion engine is received in a measurement line;
the raw CO₂ content in the flow of raw exhaust gas flowing through the measurement line is measured using a raw CO₂ analyzer;
a flow of fresh dilution air is injected into said flow of raw exhaust gas flowing through the measurement line in order to obtain a flow of diluted exhaust gas;
the diluted CO₂ content in said flow of diluted exhaust gas is measured using a diluted CO₂ analyzer;
the flow rate of said diluted exhaust gas is measured;
the dilution factor corresponding to the ratio of the measured raw CO₂ content to the measured diluted CO₂ content is calculated; and

the flow rate of the raw exhaust gas output by the internal combustion engine of the motor vehicle is deduced from the measurement of the flow rate of diluted exhaust gas and from the dilution factor.

In such a measurement method, it is necessary for the raw CO₂ analyzer and the diluted CO₂ analyzer to be provided with a priming time of a few seconds in order to be able to carry out the measurement of the CO₂ content present in the flow of raw exhaust gas or the flow of diluted exhaust gas.

Upon starting up the internal combustion engine of the motor vehicle, a first flow of raw exhaust gas is emitted into the exhaust line. This flow of raw exhaust gas is collected downstream of the exhaust line by the measurement line. The flow then reaches the raw CO₂ analyzer and then, after dilution, it reaches the diluted CO₂ analyzer.

When the flow of raw or diluted exhaust gas reaches the raw CO₂ analyzer and the diluted CO₂ analyzer, these are primed by the CO₂ contained in the flow of raw or diluted exhaust gas.

However, during this priming phase, the raw CO₂ analyzer and the diluted CO₂ analyzer do not have the time to calculate the corresponding amount of raw and diluted CO₂ contained in the flow of raw or diluted exhaust gas.

Thus, using this method it is not possible to know the raw exhaust gas dilution factor during the engine startup phase. As a result, it is not possible by calculation to obtain the flow rate of the raw exhaust gas from the flow rate of the diluted exhaust gas, the value of which is known.

Likewise, during the phases when the injection of fuel into the internal combustion engine is cut off, the raw CO₂ analyzer and the diluted CO₂ analyzer become unprimed, as they no longer measure the CO₂ content.

Here again, it is not possible to calculate the raw exhaust gas dilution factor corresponding to these fuel injection cut-off phases.

Nor is it possible, by not having the raw exhaust gas flow rate to calculate the masses of the polluting constituents during these engine start up and fuel injection cut-off phases.

However, it is particularly advantageous to know the masses of the polluting constituents emitted during the engine start up phase and the fuel injection cut-off phases, as it is during these phases that there is peak emission of hydrocarbons, carbon oxides and nitrogen oxides, these being the greatest pollutant emitters.

### SUBJECT OF THE INVENTION

To remedy the aforementioned drawbacks of the prior art, the present invention provides a CO₂ tracing method for measuring the flow rate of the raw exhaust gas output by an internal combustion engine of a motor vehicle, by which it is possible to measure the flow rate of the raw exhaust gas output by the internal combustion engine during the engine startup phase and the phases when the injection of fuel into the engine is cut off.

For this purpose, the invention provides a CO₂ tracing method for measuring the flow rate of the raw exhaust gas output by an internal combustion engine of a motor vehicle, which comprises the following steps:
a flow of raw exhaust gas output by an exhaust line of an internal combustion engine is received in a measurement line;
the raw CO₂ content in the flow of raw exhaust gas flowing through the measurement line is measured using a raw CO₂ analyzer;
a flow of fresh dilution air is injected into said flow of raw exhaust gas flowing through the measurement line in order to obtain a flow of diluted exhaust gas;
the diluted CO₂ content in said flow of diluted exhaust gas is measured using a diluted CO₂ analyzer;
the flow rate of the diluted exhaust gas is measured;
the dilution factor corresponding to the ratio of the measured raw CO₂ content to the measured diluted CO₂ content is calculated; and
the flow rate of the raw exhaust gas output by the internal combustion engine of the motor vehicle is deduced from the measurement of the flow rate of diluted exhaust gas and from the dilution factor, in which provision is made, before the internal combustion engine is started, for a known flow of a CO₂/N₂ gas mixture to be injected into the measurement line so as to prime the raw CO₂ analyzer and the diluted CO₂ analyzer.

Thus, thanks to the prior priming of the raw CO₂ analyzer and the diluted CO₂ analyzer, it is possible to measure the flow rate of the raw exhaust gas output by the internal combustion engine during the engine startup phase and the phases when the injection of fuel into the engine is cut off.

When the raw exhaust gas is output and reaches the point where the CO₂/N₂ gas mixture is injected, the meeting of the raw exhaust gas with this CO₂/N₂ gas mixture creates a gas mixture flow. Thereafter, the injection of the flow of fresh dilution air into the gas mixture flow creates a diluted gas mixture flow.

According to one advantageous feature of the method according to the invention, the known flow of CO₂/N₂ gas mixture is injected until the flow of the diluted gas mixture reaches the diluted CO₂ analyzer.

According to another advantageous feature of the method according to the invention, said known flow of CO₂/N₂ gas mixture is injected during the phases when the injection of fuel into the internal combustion engine is cut off.

According to another advantageous feature of the method according to the invention, the known flow of CO₂/N₂ gas mixture is injected throughout the duration of the process of measuring the flow rate of the raw exhaust gas.

According to another advantageous feature of the method according to the invention, upstream of the injection of the known flow of CO₂/N₂ gas mixture, the polluting constituents of the raw exhaust gas are analyzed before and after passing through a catalytic converter upon exiting the internal combustion engine.

According to another advantageous feature of the method according to the invention, before the flow rate of said diluted gas mixture is measured, a portion of the volume of the diluted gas mixture is taken off into a sampling bag in order to carry out an overall analysis, at the end of the measurement cycle, of the polluting constituents of the diluted gas mixture.

According to another advantageous feature of the method according to the invention, during the step of injecting the flow of fresh dilution air into the gas mixture flow, a portion of the volume of fresh dilution air is collected in a sampling bag.

According to another advantageous feature of the method according to the invention, to calculate the flow rate of the raw exhaust gas output by the internal combustion engine, the volume of diluted gas mixture taken off into the corresponding sampling bag and the volume of the raw exhaust gas taken off by the analyzers for analyzing the polluting constituents of the raw exhaust gas and the raw CO₂ analyzer are taken into account.

The invention also relates to a measurement installation for implementing the CO₂ tracing method of measurement, which comprises:
a measurement line suitable for being connected to an outlet of an exhaust line of an internal combustion engine;
a raw CO₂ analyzer positioned on the measurement line in order to measure the raw CO₂ content in the flow of raw exhaust gas coming from said exhaust line;
means for injecting fresh dilution air into the measurement line downstream of the raw CO₂ analyzer;
a diluted CO₂ analyzer, positioned on the measurement line, for measuring the diluted CO₂ content in the flow of diluted gas mixture;
means for measuring the flow rate of the diluted gas mixture; and
means for determining the flow rate of the raw exhaust gas from the measurement of the flow rate of the diluted gas mixture, from the raw CO₂ content and from the diluted CO₂ content,
   characterized in that it includes upstream of tile raw CO₂ analyzer, means for injecting a known flow of a CO₂/N₂ gas mixture into the measurement line so as to prime the raw CO₂ analyzer and the diluted CO₂ analyzer.

Other nonlimiting and advantageous features of the installation for measuring the flow rate of the raw exhaust gas according to the invention are the following:
it includes analyzers for analyzing the polluting constituents of the raw exhaust gas and the means for injecting the flow of CO₂/N₂ gas mixture are placed downstream of the analyzers for analyzing the polluting constituents of the raw exhaust gas;
it includes at least one sampling bag suitable for taking off a portion of the volume of the diluted gas mixture;
it includes, upstream of the means for injecting fresh dilution air, at least one sampling bag suitable for taking off a portion of the volume of fresh dilution air;
it includes rollers placed beneath the driven wheels of a motor vehicle driven by an internal combustion engine that are suitable for driving said motor vehicle; and
it includes means for receiving an internal combustion engine of a motor vehicle connected to the exhaust line.

### DETAILED DESCRIPTION OF EXEMPLARY EMBODIMENTS

The following description with regard to the appended drawings, given by way of nonlimiting examples, will make it clearly understood what the invention consists of and how it can be realized.

In the appended drawings:

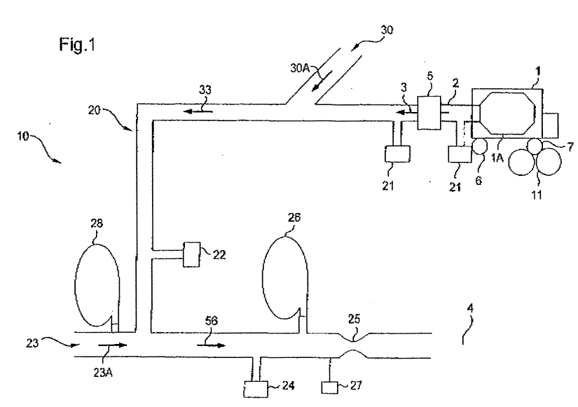

FIG. 1 is an overall view of the measurement installation according to a first embodiment in accordance with the invention; and

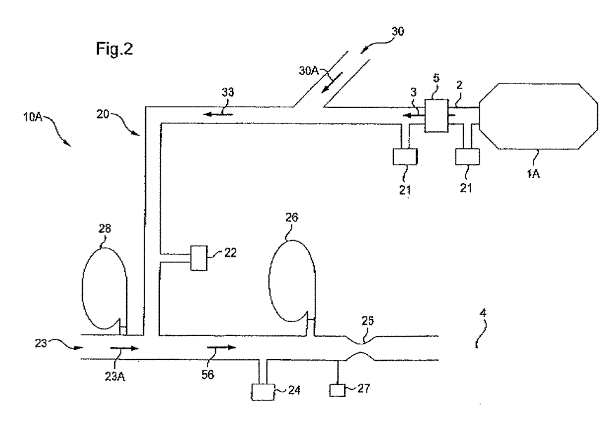

FIG. 2 is an overall view of the measurement installation according to a second embodiment in accordance with the invention.

FIGS. 1 and 2 show two embodiments of a measurement installation 10; 10A for implementing, a CO₂ tracing method for measuring the flow rate of the raw exhaust gas 3 output by an internal combustion engine 1A of a motor vehicle 1.

This measurement installation 10; 10A comprises a measurement line 20 suitable for being connected to an outlet of an exhaust line 2 of an internal combustion engine 1A, which here includes a catalytic converter 5.

A raw CO₂ analyzer 22 is provided on the measurement line 20 in order to measure the raw CO₂ content in the flow of gas flowing in the measurement line 20 from said exhaust line 2.

Furthermore, downstream of the raw CO₂ analyzer 22, means 23 for injecting fresh dilution air 23A into the measurement line 20 are provided.

After said injection means 23, a diluted CO₂ analyzer 24 is positioned on the measurement line 20 in order to measure the diluted CO₂ content in the flow of gas flowing in the measurement line 20.

At the end of the measurement installation 10; 10A and before venting to atmosphere 4, means 25, 27 for measuring the flow rate of the gas flowing in the measurement line 20 are provided.

These means consist here of a sonic throat 25 and of pressure and temperature measurement means 27 upstream of the sonic throat 25

Furthermore, means (not shown here) are used to determine by calculation the flow rate of the raw exhaust gas 3 from the measurement of the flow of gas flowing in the measurement line 20, from the raw CO₂ content and from the diluted CO₂ content.

Advantageously, according to the invention, the measurement installation includes, upstream of the raw CO₂ analyzer, means 30 for injecting a known flow of a CO₂/N₂ gas mixture 30A into the measurement line 20 so as to prime the raw CO₂ analyzer 22 and the diluted CO₂ analyzer 24 before the engine 1A is started up.

When the raw exhaust gas 3 is output and reaches the point where the CO₂/N₂ gas mixture is injected, the meeting of the raw exhaust gas 3, with this CO₂/N₂ gas mixture 30A creates a gas mixture flow 33. Thereafter, the injection of the flow of fresh dilution air 23A into the gas mixture flow 33 creates a diluted gas mixture flow 56.

Said injection means 30 are sufficiently precise for the flow rate of the CO₂/N₂ mixture injected into the measurement line to be known with certainty and so that it can be subsequently subtracted from the flow rate of the raw exhaust gas calculated from the dilution factor.

In addition, these injection means 30 must be mounted sufficiently upstream of the raw CO₂ analyzer so as to obtain, after the engine 1A has been started up, a homogeneous flow of gas mixture 33.

Finally, these injection means 30 must be insensitive to the pressure fluctuations in the exhaust line 2.

For calculating the concentrations of the polluting constituents, the measurement installation 10; 10A includes analyzers 21 for analyzing the polluting constituents of the raw exhaust gas 3 placed on either side of a catalytic converter 5, and the means 30 for injecting the flow of CO₂/N₂ gas mixture 30A are placed downstream of these polluting-constituent analyzers 21.

Furthermore, according to the typical case shown, the measurement installation 10; 10A includes a sampling bag 26 suitable for taking off a portion of the volume of the diluted gas mixture 56 and, upstream of the means 23 for injecting fresh dilution air 23A, at least one sampling bag 28 suitable for taking off a portion of the volume of fresh dilution air 23A.

According to the embodiment of the invention shown in FIG. 1, the measurement installation 10 includes rollers 11 placed beneath the driven wheels 7 of a motor vehicle 1 powered by an internal combustion engine 1A that are suitable for driving said motor vehicle 1, the nondriven wheels of the motor vehicle being moreover blocked in order to avoid entertainment of the vehicle.

According to the embodiment of the invention shown in FIG. 2, the measurement installation 10A includes means for receiving an internal combustion engine 1A connected to the exhaust line 2.

The two embodiments of the installation according to the invention shown in FIGS. 1 and 2 are advantageously used for implementing a CO₂ tracing method for measuring the flow rate of the raw exhaust gas 3 output by an internal combustion engine 1A of a motor vehicle 1.

According to this method, before the internal combustion engine 1A of the motor vehicle 1 is started up, a known flow of a CO₂/N₂ gas mixture 30A is injected into the measurement line 20 so as to prime the raw CO₂ analyzer 22 and the diluted CO₂ analyzer 24.

The CO₂ is mixed with N₂ so as not to saturate the raw CO₂ analyzer and the diluted CO₂ analyzer 24.

Next, the engine 1A is started up so as to receive in the measurement line 20 a flow of raw exhaust gas 3 output by the exhaust line 2 of the internal combustion engine 1A after said raw exhaust gas 3 has passed through the catalytic converter 5.

At the point of injection of the CO₂/N₂ gas mixture 30A, the meeting of the raw exhaust gas 3 with this CO₂/N₂ gas mixture 30A creates a gas mixture flow 33.

When this gas mixture 33 reaches the raw CO₂ analyzer 22, the latter measures the raw CO₂ content in the flow of this gas mixture 33 flowing through the measurement line 20.

After the content of raw CO₂ in the gas mixture flow 33 has been measured, a flow of fresh dilution air 23A is injected into the gas mixture flow 33 to reduce the deleterious effect of water on the measurements carried out on the gas mixture 33 during the overall analysis, at the end of the measurement cycle, of the polluting constituents of the diluted gas mixture. This injection of fresh dilution air 23A into the flow of gas mixture 33 creates a flow of diluted gas mixture 56.

The flow of fresh dilution air 23A is adapted to the driving cycle studied, consisting of slowing-down phases, steady-speed phases and acceleration phases.

Diluted CO₂ content in said flow of diluted gas mixture 56 is then measured using a diluted CO₂ analyzer 24.

Next, the flow rate of said diluted gas mixture 56 is determined by measuring, thanks to the measurement means 25, 27, the temperature and pressure upstream of the sonic throat 27, the characteristics of which are known.

Finally, the dilution factor corresponding to the ratio of the measured raw CO₂ content to the measured diluted CO₂ content is calculated.

It is then possible for the flow rate of the raw exhaust gas 3 output by the internal combustion engine 1A to be deduced from the measurement of the flow rate of the diluted gas mixture 56 and from the dilution factor.

It should be pointed out that the known flow of CO₂/N₂ gas mixture 30A is injected at least until the flow of diluted gas mixture 56 reaches the diluted CO₂ analyzer 24.

Thereafter, said known flow of CO₂/N₂ gas mixture 30A is injected on detecting cut-offs in the injection of fuel into the internal combustion engine 1A.

This injection of CO₂/N₂ gas mixture 30A during phases when the injection of fuel into the engine 1A is Cut off avoids having an indeterminate form of the dilution factor during the fuel injection cut-off phases and ensures continuity in the measurement of the flow rate of the raw exhaust gas 56 output by the engine 1A.

To simplify the calculations, the CO₂/N₂ gas mixture 30A may be injected throughout the duration of the process of measuring the flow rate of raw exhaust gas 3.

The polluting-constituent analyzers 21 give the concentrations of the principal polluting constituents, which here are mainly carbon oxides, hydrocarbons, nitrogen oxides and carbon dioxide.

The polluting constituents of the raw exhaust gas 3 are analyzed upstream of the injection of the known flow of CO₂/N₂ gas mixture 30A before and after passing through the catalytic converter 5 at the output of the internal combustion engine 1A.

Since the raw and diluted CO₂ analyzers 22, 24 are primed, masses of the various polluting constituents of the raw exhaust gas 3 can be calculated second by second.

Furthermore, according to this method, before the flow rate of said diluted gas mixture 56 is measured, a portion of the volume of the diluted gas mixture 56 is taken off into a sampling bag 26 in order to carry out an overall analysis at the end of the measurement of the polluting constituents of the diluted gas mixture 56.

Likewise, during injection of the flow of fresh dilution air 23A into said flow of raw exhaust gas 3, a portion of the volume of fresh dilution air 23A is recovered in a sampling bag 28 for the overall calculation of the masses of the polluting constituents over the cycle from the measured concentrations of these polluting constituents in the sampling bags.

It should also be pointed out that, for calculating the flow rate of the raw exhaust gas 3 output by the internal combustion engine 1A, the volume of diluted gas mixture 56 taken off into the corresponding sampling bag 26 and the volume of the raw exhaust gas 3, 33 taken off by the analyzers 21 for analyzing the polluting constituents of the raw exhaust gas and the raw CO₂ analyzer 22 are taken into account.

Thanks to the raw CO₂ analyzer 22 and the diluted CO₂ analyzer 24 being primed according to the invention, it is possible to measure the flow rate of the raw exhaust gas 3 output by the internal combustion engine 1A during the startup phase of the engine 1A and during the phases when the injection of fuel into the engine 1A is cut off.

Thus, knowing the flow rate of the raw exhaust gas 3, the concentration of all the polluting constituents of the raw exhaust gas 3, their density, and the flow rate of the injected CO₂/N₂ mixture, it is then possible to calculate the mass of the polluting constituents of the exhaust gas second by second, in particular during the startup and fuel injection cut-off phases.

The present invention is in no way limited to the embodiments described and shown, rather a person skilled in the art will be capable of providing any variant thereof consistent with its purview.

1. A CO₂ tracing method for measuring the flow rate of the raw exhaust gas (3) output by an internal combustion engine (1A) of a motor vehicle (1), which comprises the following steps:
a) a flow of raw exhaust gas (3) output by an exhaust line (2) of an internal combustion engine (1A) is received in a measurement line (20);
b) the raw CO₂ content in the flow of raw exhaust gas (3) flowing through the measurement line (20) is measured using a raw CO₂ analyzer (22);
c) a flow of fresh dilution air (23A) is injected into said flow of raw exhaust gas (3) flowing through the measurement line (20) in order to obtain a flow of diluted exhaust gas (56);
d) the diluted CO₂ content in said flow of diluted gas mixture (56) is measured using a diluted CO₂ analyzer (24);
e) the flow rate of the diluted exhaust gas (56) is measured;
f) the dilution factor corresponding to the ratio of the measured raw CO₂ content to the measured diluted CO₂ content is calculated; and
g) the flow rate of the raw exhaust gas (3) output by the internal combustion engine (1A) is deduced from the measurement of the flow rate of diluted exhaust gas (56) and from the dilution factor,
characterized in that, before the internal combustion engine (1A) is started, a known flow of a CO₂/N₂ gas mixture (30A) is injected into the measurement line (20) so as to prime the raw CO₂ analyzer (22) and the diluted CO₂ analyzer (24) used in steps b) and d).

2. The method as claimed in claim 1, characterized in that the known flow of CO₂/N₂ gas mixture (30A) is injected until the flow of the diluted gas mixture (56) reaches the diluted CO₂ analyzer (24).

3. The method as claimed in claim 1, characterized in that said known flow of CO₂/N₂ gas mixture (30A) is injected during the phases when the injection of fuel into the internal combustion engine (1A) is cut off.

4. The method as claimed in claim 1, characterized in that the known flow of CO₂/N₂ gas mixture (30A) is injected throughout the duration of the process of measuring the flow rate of the raw exhaust gas (3).

5. The method as claimed in claim 1, characterized in that, upstream of the injection of the known flow of CO₂/N₂ gas mixture (30A), the polluting constituents of the raw exhaust gas (3) are analyzed before and after passing through a catalytic converter (5) upon exiting the internal combustion engine (1A).

6. The method as claimed in claim 1, characterized in that, before step e), a portion of the volume of the diluted gas mixture (56) is taken off into a sampling bag (26) in order to carry out a measurement of the polluting constituents of the diluted gas mixture (56).

7. The method as claimed in claim 6, characterized in that, during step c), a portion of the volume of fresh dilution air (23A) is collected in a sampling bag (28).

8. The method as claimed in claim 6, characterized in that, to carry out step g), the volume of diluted gas mixture (56) taken off into the corresponding sampling bag (26) and the volume of the raw exhaust gas (3, 33) taken off by the analyzers (21) for analyzing the polluting constituents of the raw exhaust gas and the raw CO₂ analyzer (22) are taken into account.

9. A measurement installation (10; 10A) for implementing the CO₂ tracing method of measurement as claimed in claim 1, which comprises:
a measurement line (20) suitable for being connected to an outlet of an exhaust line (2) of an internal combustion engine (1A);
a raw CO₂ analyzer (22) positioned on the measurement line (20) in order to measure the raw CO₂ content in the flow of raw exhaust gas (3) coming from said exhaust line (2);
means (23) for injecting fresh dilution air (23A) into the measurement line (20) downstream of the raw Coe analyzer (22);
a diluted CO₂ analyzer (24), positioned on the measurement line (20), for measuring the diluted CO₂ content in the flow of diluted gas mixture (56); and
means (25, 27) for measuring the flow rate of the diluted gas mixture (56) and means for determining the flow rate of the raw exhaust gas (3) from the measurement of the flow rate of the diluted gas mixture (56), from the raw CO₂ Content and from the diluted CO₂ content,
characterized in that it includes upstream of the raw CO₂ analyzer (22), means (30) for injecting a known flow of a CO₂/N₂ gas mixture (30A) into the measurement line (20) so as to prime the raw CO₂ analyzer (22) and the diluted CO₂ analyzer (24).

10. The measurement installation (10; 10A) as claimed in claim 9, characterized in that it includes analyzers (21) for analyzing the polluting constituents of the raw exhaust gas (3) and in that the means (30) for injecting the flow of CO₂/N₂ gas mixture (30A) are placed downstream of the analyzers (21) for analyzing the polluting constituents of the raw exhaust gas (3).

11. The measurement installation (10; 10A) as claimed in claim 9, characterized in that it includes at least one sampling bag (26) suitable for taking off a portion of the volume of the diluted gas mixture (56).

12. The measurement installation (10; 10A) as claimed in claim 11, characterized in that it includes, upstream of the means (23) for injecting fresh dilution air (23A), at least one sampling bag (28) suitable for taking off a portion of the volume of fresh dilution air (23A).

13. The measurement installation (10; 10A) as claimed in claim 10, characterized in that it includes rollers (11) placed beneath the driven wheels (7) of a motor vehicle (1) powered by an internal combustion engine (1A) that are suitable for driving said motor vehicle (1).

14. The measurement installation (10; 10A) as claimed in claim 10, characterized in that it includes means for receiving an internal combustion engine (1A) of a motor vehicle (1) connected to the exhaust line (2).
